(19) United States
(12) Patent Application Publication
(10) Pub. No.: US 2025/0122789 A1
(43) Pub. Date: Apr. 17, 2025

(54) Stimulating Hydrocarbon Production in a Subsurface Reservoir

(71) Applicant: Saudi Arabian Oil Company, Dhahran (SA)

(72) Inventors: Waheed Syed Arshad, Dhahran (SA); Otto Meza Camargo, Dhahran (SA); Rayan Alidi, Dhahran (SA)

(21) Appl. No.: 18/488,583

(22) Filed: Oct. 17, 2023

(51) Int. Cl. E21B 43/26; E21B 43/12; E21B 49/00; E21B 49/08; G01V 9/00

(52) U.S. Cl. CPC E21B 43/26; E21B 49/008; E21B 49/087; G01V 9/005; E21B 43/12; E21B 2200/20

(57) ABSTRACT

Systems and methods for performing targeted stimulation of a well drilled in a subsurface formation include performing a dynamic well test in the well; logging the well to generate one or more diagnostic well logs prior to stimulating the subsurface formation; identifying one or more zones in the well for targeted stimulation based on the injection test and the one or more diagnostic well logs; and performing the targeted stimulation at the identified one or more zones.

### TECHNICAL FIELD

This disclosure relates to stimulating hydrocarbon production in a subsurface reservoir.

### BACKGROUND

In some cases, one-third of perforation clusters do not yield oil or gas. Knowing where to appropriately place perforations and also determine the best hydraulic fracturing stages still remains a challenge for the oil and gas industry. The industry has progressed considerably from the early stages of choosing a geometric perforation cluster scheme to a more sophisticated workflow with enhanced production-based weighted criteria such as facies quality, effective porosity, and brittleness to quantify the differences in reservoir character and a separate set of fracturing-based weighted criteria such as closure stress, natural fracture index, and cement bond index to highlight areas of differing mechanical properties or mechanical risk. Even after having these elaborate weighted criteria, the wells face formation breakdown issues and poor productivity.

### SUMMARY

Horizontal well drilling in low permeability, tight reservoirs can require further well stimulation to meet production goals. Horizontal well completions by themselves may not suffice to deliver production targets. In long openhole wellbores, successful fracture stimulation can be difficult to achieve because of the difficulty in placing fractures where they are needed along the lateral and production can be compromised. In some cases, hydrocarbon production from a tight oil/gas well can be dominated by contributing natural fractures. Not all natural fractures are “active” contributing fractures following a fracture treatment. Some natural fractures because of completion design may be “trapped” in unplanned spaces between packers with no inlet into the production tubing to contribute to production.

This disclosure describes systems and methods for stimulating hydrocarbon production in a subsurface reservoir. A dynamic well test is performed on a well drilled into the subsurface reservoir. The well is logged to generate one or more diagnostic well logs prior to stimulating the subsurface formations. For example, diagnostic well logs include spectral noise logs and high precision temperature logs. One or more zones in the well are identified for targeted stimulation based on the dynamic test and the one or more diagnostic well logs. The targeted stimulation is performed in the well at the identified one or more zones. For example, the targeted stimulation can include hydraulic fracturing or hydrajet-assisted hydraulic fracturing.

Implementations of the systems and methods of this disclosure can provide various technical benefits. Potentially contributing fractures (natural fractures or hydraulic fractures) can be identified in wells before or after completion. Using diagnostic logs such as spectral noise logs or high precision temperature logs can help identify fractures that are not readily apparent from conventional petrophysical logs. The diagnostic logs and dynamic tests can identify optimal intervals in the well for targeted stimulation. Identified zones can be stimulated with targeted stimulation techniques to reduce wasted perforations, help reduce breakdown pressures and inconsistent breakdown and treating pressures, minimize proppant screen-out situations and avoid fracturing non-productive rock. The presence of the critical fractures can be validated by physically capturing the fractures through actual fluid movement behind pipe on temperature and noise logs from areas that were predicted in a model.

The details of one or more embodiments of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic illustrating a wellbore system.

FIG. 2 is a flowchart of a method for selectively stimulating hydrocarbon production in a subsurface reservoir.

FIGS. 3A-3D illustrate types of completions for a wellbore.

FIGS. 4A-4B illustrate selective stimulation of a subsurface reservoir using hydrajet-assisted hydraulic fracturing.

FIG. 5 is a composite plot of an injection profile using water in a horizontal wellbore.

FIG. 6 is a composite plot of a production profile with gas along the horizontal wellbore in FIG. 5.

FIG. 7 is a composite plot of a production profile with oil and water along a horizontal wellbore.

FIG. 8 is a composite plot illustrating fracture stages and fracture ports along a horizontal wellbore.

FIG. 9 is a composite plot showing top and middle zone contributions away from perforation intervals in a vertical wellbore.

FIG. 10 shows a composite log that contains a brittleness model, a fracture density index, tadpoles that represent fluid flow paths for a wellbore, and logging data according to the present disclosure.

FIG. 11 illustrates hydrocarbon production operations that include field operations and computational operations, according to some implementations.

FIG. 12 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

This specification describes systems and methods for stimulating hydrocarbon production in a subsurface reservoir. A dynamic test is performed on a well drilled into the subsurface reservoir. The well is logged to generate one or more diagnostic well logs prior to stimulating the subsurface formations. For example, diagnostic well logs can include spectral noise logs and high precision temperature logs. One or more zones in the well are identified for targeted stimulation based on the injection test and the one or more diagnostic well logs. The targeted stimulation is performed in the well at the identified one or more zones. For example, the targeted stimulation can include hydraulic fracturing or hydrajet-assisted hydraulic fracturing.

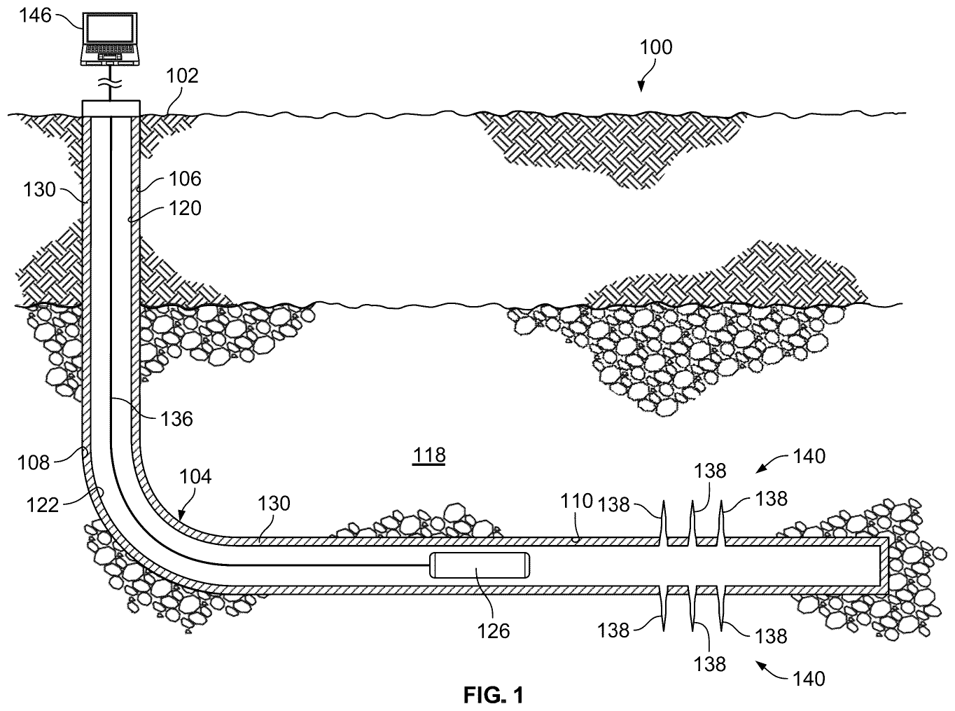

FIG. 1 is a schematic diagram of an example of a wellbore system 100. In some aspects, the wellbore system 100 (all or part of it) includes a computational framework (for example, control system 146) for predicting the breakdown pressure of a subsurface formation 118. The wellbore system 100 includes one or more boreholes and/or one or more borehole segments. For example, the wellbore system 100 includes a borehole 104 formed (for example, drilled or otherwise) from a ground surface 102 into the subsurface formation 118. Although the ground surface 102 is illustrated as a land surface, the ground surface 102 may be a sub-sea or other underwater surface, such as a lake or an ocean floor or other surface under a body of water. The borehole 104 may be formed under a body of water from a drilling location on or proximate the body of water.

The borehole 104 is a directional borehole that includes a substantially vertical portion 106 coupled to a radiused or curved portion 108, which in turn is coupled to a substantially horizontal portion 110. The three portions of the borehole 104—the vertical portion 106, the radiused portion 108, and the horizontal portion 110—form a continuous borehole 104 that extends into the Earth.

As used in the present disclosure, “substantially” in the context of a borehole orientation, refers to boreholes that may not be exactly vertical (for example, exactly perpendicular to the ground surface 102) or exactly horizontal (for example, exactly parallel to the ground surface 102). In some cases, the borehole 104 is inclined relative to the ground surface 102. In other words, those of ordinary skill in the drill arts would recognize that vertical boreholes often undulate offset from a true vertical direction that they might be drilled at an angle that deviates from true vertical, and horizontal boreholes often undulate offset from a true horizontal direction. Further, the substantially horizontal portion 110, in some aspects, may be a slant borehole or other directional borehole that is oriented between exactly vertical and exactly horizontal. The substantially horizontal portion 110, in some aspects, may be oriented to follow a slant of the formation. At least a portion of the borehole 104, such as the radiused portion 108 and the horizontal portion 110, may be considered an inclined or deviated borehole, in other words, a non-vertical borehole.

The borehole 104 has a surface casing 120 positioned and set around the borehole 104 from the ground surface 102 into a particular depth in the Earth. For example, the surface casing 120 may be a relatively large-diameter tubular member (or string of members) set (for example, cemented) around the borehole 104 in a shallow formation. As used herein, “tubular” may refer to a member that has a circular cross-section, elliptical cross-section, or other shaped cross-section. As illustrated, a production casing 122 is positioned and set within the borehole 104 downhole of the surface casing 120. Although termed a “production” casing, in this example, the casing 122 may or may not have been subject to hydrocarbon production operations. Thus, the casing 122 refers to and includes any form of tubular member that is set (for example, cemented) in the borehole 104 downhole of the surface casing 120. In some examples of the wellbore system 100, the production casing 122 may begin at an end of the radiused portion 108 and extend throughout the substantially horizontal portion 110. The casing 122 could also extend into the radiused portion 108 and into the vertical portion 106.

Cement 130 is positioned (for example, pumped) around the casings 120 and 122 in an annulus between the casings 120 and 122 and the borehole 104. The cement 130, for example, may secure the casings 120 and 122 (and any other casings or liners of the borehole 104) through the subsurface layers under the ground surface 102. In some aspects, the cement 130 may be installed along the entire length of the casings (for example, casings 120 and 122 and any other casings), or the cement 130 could be used along certain portions of the casings if adequate for the particular borehole 104. Other casings, such as conductor casings or intermediate casings, can be used in the wellbore system 100.

The borehole 104 extends through one or more subsurface layers (not specifically labeled) and lands in subsurface formation 118. The subsurface formation 118, in this example, may be chosen as the landing for the substantially horizontal portion 110, for example, in order to initiate completion operations such as hydraulic fracturing operations and ultimately recover hydrocarbon fluids from the subsurface formation 118. In some examples, the subsurface formation 118 is composed of shale or tight sandstone. Shale, in some examples, may be source rocks that provide for hydrocarbon recovery from the subsurface formation 118.

The borehole 104 includes one or more perforation channels 138 that radially extend from the borehole 104. In some examples, the perforation channels 138 extend through the casing 122 and the cement 130, and into the subsurface formation 118. In some examples, the one or more perforation channels 138 are the borehole segments. Generally, a borehole segment is length segment of the borehole where fracturing operations are desired. In some examples, the borehole segment is some of the perforation channels 138. In some examples, the borehole segment is an end segment 139 of the borehole 104.

In some examples, the perforation channels 138 are formed by, for example, shaped explosive charges, water jetting, laser, or other conventional perforating techniques. In some aspects, multiple perforation channels 138 may include a perforation stage 140. Each perforation channels 138, as well as each perforation cluster 140, may provide a path (or paths) for a hydraulic fracturing liquid (with or without proppant) to enter the subsurface formation 118 from the borehole 104 in order to initiate and propagate hydraulic fractures (extending from the perforation channels 138) through the subsurface formation 118. In some examples, the perforation channels 138 and/or the borehole 104 contains mud.

The wellbore system 100 includes a well log instrument 126 communicably coupled to a downhole conveyance 136, such as a wirelines, optical line, or other data communication cable. The downhole conveyance 136 provides data from the well log instrument 126 to the control system 146, for real time (for example, during logging operations) or later usage in measuring one or more properties of the borehole 104.

In some examples, the data from the well log instrument 126 represents geometric data associated with a borehole segment of the borehole 104 and includes information regarding a length of the borehole segment, a radius of the borehole segment, an inclination angle of the borehole segment, and/or an azimuth angle of the borehole segment. In some examples, the data from the well log instrument 126 represents information identifying a rock of the subsurface formation 118. In some examples, the data represents information about a permeability of the rock. In some examples, the data from the well log instrument 126 represents information about a thickness of filter cake within and/or surrounding the borehole segment. In some examples, the data represents information about a permeability of the filter cake. In some examples, the data from the well log instrument 126 represents information about in-situ stresses and/or pore pressures within and/or surrounding the borehole segment.

In some examples, the control system 146 includes a microprocessor based control system that includes, for example, one or more hardware processors, one or more memory storage devices (for example, tangible, non-transitory computer-readable memory modules), one or more network interfaces, and one or more input/output devices, including, for example, a graphical user interface (GUI) to present one or more determinations or data from the computer framework for predicting the breakdown pressure of the subsurface formation 118.

In some examples, the control system 146 implements computer software to determine the breakdown pressure associated with one or more borehole segments of the borehole 104. For example, the one or more of the perforation channels 138 of the borehole 104 or the end segment 139 of the borehole 104. In some examples, the control system 146 is located on-site at the borehole 104. For example, the control system 146 can be located within an on-site building, trailer, or vehicle. In some examples, the control system 146 is located off-site from the borehole 104. For example, the control system 146 can be located at a remote data center or an engineering facility.

The wellbore system 100 includes a hydraulic pump 147 operable to pump a fluid into the borehole 104 to fracture the borehole segment. The hydraulic pump 147 pumps fluid into the borehole 104 with a pressure approximately equal to the predicted breakdown pressure to fracture the subsurface formation 118 surrounding the borehole segment. The control system 146 controls the hydraulic pump 147 to pump the hydraulic fluid into the borehole 104 and into the borehole segment.

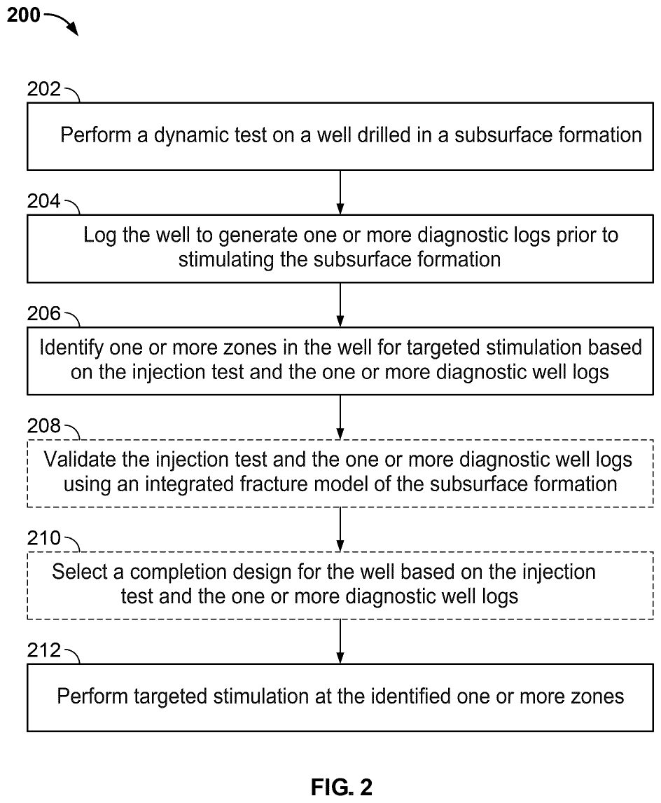

FIG. 2 is a flowchart for an example method 200 for stimulating hydrocarbon production in a subsurface formation. In some implementations, one or more steps of method 200 can be performed with or by a data processing system (e.g., the control system 146 of FIG. 1). The method 200 provides flexibility in stimulation treatment design to access zones of interest without being limited by the completion design or other physical factors. The method 200 uses dynamic tests and diagnostic well logs in pre-stimulation assessment of wellbores to identify natural fractures or potentially productive intervals in openholes or behind uncemented pipe.

A dynamic test is performed on a well drilled in the subsurface formation (step 202). The dynamic test can be, for example, an injection test and/or a production test. An injection test can establish flow profiles in the well to identify fractures, fracture contribution to production, and fracture distribution. The injection test can be conducted before a completion is installed in the well bore. Fluid distribution in a long lateral can be highly dependent on the heterogeneity of the reservoir where natural fractures and high permeability streaks can dominate most of the fluid intake at certain injection rates. By changing the injection rates, a varied fluid distribution profile can be generated.

In some implementations, a production test is performed on the well. In a production mode a different fluid distribution profile can be revealed, as compared with the injection test, in the same wellbore where prolific zones at deeper depths get an opportunity to produce without the contribution being masked by shallower prolifically producing zones. The production test is performed by flowing the well and producing its content, e.g., gas or oil from the subsurface formation.

The well is logged to generate one or more diagnostic logs prior to stimulating the subsurface formation (step 204). The diagnostic logs can include at least one spectral noise log (SNL) and at least one high precision temperature log (HPT). Performing diagnostic logging before stimulating the subsurface can be effective for identifying natural fractures behind pipe or potentially productive intervals. Using HPT/SNL logs run in conjunction with injection and/or production modes can reveal the presence (or absence) of natural fractures inconspicuous in reservoirs known to be extremely tight with very low permeabilities. Such findings can be verified or discarded through numerical simulation of temperature logs.

High precision temperature (HPT) logging can be an efficient technique to locate inflow intervals in the reservoir, evaluate inflow rates in them and the drawdown pressure that creates temperature disturbance, detect cross-flows in the wellbore and/or behind casing and check for casing, tubing and bottom-hole leakages. HPT logging can detect wellbore flows with rates much below a mechanical spinner's threshold that is typically run with production logging tools (PLT) assembly. Another application of temperature logging is picking flow zones behind unperforated casing that develop through behind-casing channeling.

Regarding SNL, fluid movement generates acoustic noise and the intensity (amplitude) of the noise is proportional to the differential pressure. The noise spectrum on the other hand depends on the medium in which the fluid moves. Larger pores generate low frequency noise whereas small pores produce high frequency noise. However, the boundaries of the frequency spectrum are not well defined and there are overlaps. Nonetheless, a High Definition Spectral Noise Tool (SNL-HD) can provide reasonable information about the nature of the noise origin. It is based on the analysis of data acquired by a broadband high-definition spectral acoustic logging tool. The acoustic signal component produced by fluid flow through the rock matrix can be distinguished from other acoustic signals caused, for example, by wellbore or channel flows by its frequency features. The layer formation pressure can be determined by numeric simulation using an empirical correlation between the reservoir fluid flow velocity, pressure gradient, and the reservoir-related component of acoustic power.

In some implementations, step 204 can include both HPT logging and SNL. For example, fluids moving through the reservoir to the well system have thermal mass and can heat or cool the areas they touch. These temperature changes carry information about fluid behavior, particularly flow rates and profiles. However, the physical laws of thermo-hydrodynamics are complex, and the interactions between them even more so. Combining both HPT logging and SNL with array production logging can provide a complete evaluation of borehole and behind liner flow and allows for better optimization of reservoir production in such challenging environments.

Using diagnostic well logs in injection and production modes can reveal the presence (or absence) of natural fractures inconspicuous in reservoirs known to be extremely tight with very low permeabilities. Additionally in high permeability reservoirs the flow profile can be dominated by prolific zones with no stimulation performed. The method 200 can establish flow profiles with different fluids (gas or liquids) which can be applied in different well conditions to extend the investigation in long horizontal wellbores for fracture identification, fracture contribution, and fracture distribution. Using advanced thermodynamic and hydrodynamic models the temperature, pressure and other well system data can be transformed into accurate and continuous reservoir flow profiles. These models when supported by acoustic data (e.g., SNL) can distinguish between flow regimes (e.g., linear flow) to identify natural fractures (or hydraulic fractures) along the wellbore.

One or more zones in the well can be identified for targeted stimulation based on the injection test and the one or more diagnostic well logs (step 206). The natural fractures and fluid contributing zones identified through the diagnostic logs (as explained in above steps 0036-0041) are the target zones for stimulation which otherwise would not be discernible on regular petrophysical logs.

The data generated by the injection test and the diagnostic well logs can be validated using an integrated fracture model of the subsurface formation (step 208). Numerical temperature simulations can be used to model the wellbore, multilayer reservoir and surrounding rocks as well as fluid flows in multilayer reservoir system and a wellbore with respect to cross-flows and channeling between the units. The temperature variations can be coupled by the thermodynamic effects that occur while fluid flows through the subsurface formation and wellbore. Modeling can show that, along with wellbore flow and reservoir pressure verification, HPT logging is capable to distinguish active reservoir zones behind perforations, which cannot be reliably captured by spinners in a PLT run. The comparison of computed model results with HPT logging data enhances the interpretation of temperature data and quantifies wellbore and reservoir performance.

The integrated fracture modeling process can include two stages. A first processing stage takes the form of a geomechanics fracture controller, while a second processing stage produces a predicted natural fracture model which is represented as fracture density index (FDI).

The geomechanics fracture controller involves integration between a paleo-stress from a structural restoration model obtained for several stages in geological time, and current stress regime conditions obtained through a geomechanical numerical simulation model. This step involves seismic volume interpretation techniques and attributes that can be applied to detect possible faults and natural fracture alignments by using post stack discontinuities attributes, azimuthal analysis and elastic seismic inversion.

The natural fracture model prediction processing stage is performed to quantify fracture density in the subsurface formation using the geomechanics fracture controller results, and fracture characterization provided from core samples and borehole well log images from a borehole image (BHI) analysis process. This sub-step can also determine fracture dimensions and their properties. Examples of the fracture properties include fracture position, orientation, geometry, porosity, aperture, permeability, and the like.

A 1D mechanical earth model (MEM) of the geomechanics fracture controller can determine the rock mechanical properties and stress regime conditions in the subsurface formation. The 1D MEM process starts with computing the elastic rock mechanical properties derived from well logs and rock mechanical tests; and using additional information such as reservoir formation pressures and a Formation Integrity Test (FIT), the in situ stress regime can be predicted and mechanical stratigraphy (Geomechanical Facies) computed. Thus, mechanical stratigraphy conforms the rock mechanical response to the geological deformation process and can be used as constraints for natural fractures presence, constraining their development to some particular layer through brittleness concepts, depending also on the deformation magnitude. Additionally, the maximum horizontal stress direction which can be detected by a Borehole Image Analysis (BHI), and the in situ stress magnitude derived from 1D MEM process are used to predict the stress regime.

A 2D/3D geomechanics forward model process of the natural fracture model prediction processing stage combines a structural model and displacement, paleo-stress and strain measures from the structural restoration model with petrophysical properties from a geological model. The results take the form of structural restoration as horizons displacement and deformation using boundary conditions. The 2D/3D geomechanics forward model process can be performed as a Finite Element Method (FEM) using geomechanics numerical simulation software, to estimate the tensor stress regime corresponding to the deformation estimate from structural restoration at the in situ stress conditions.

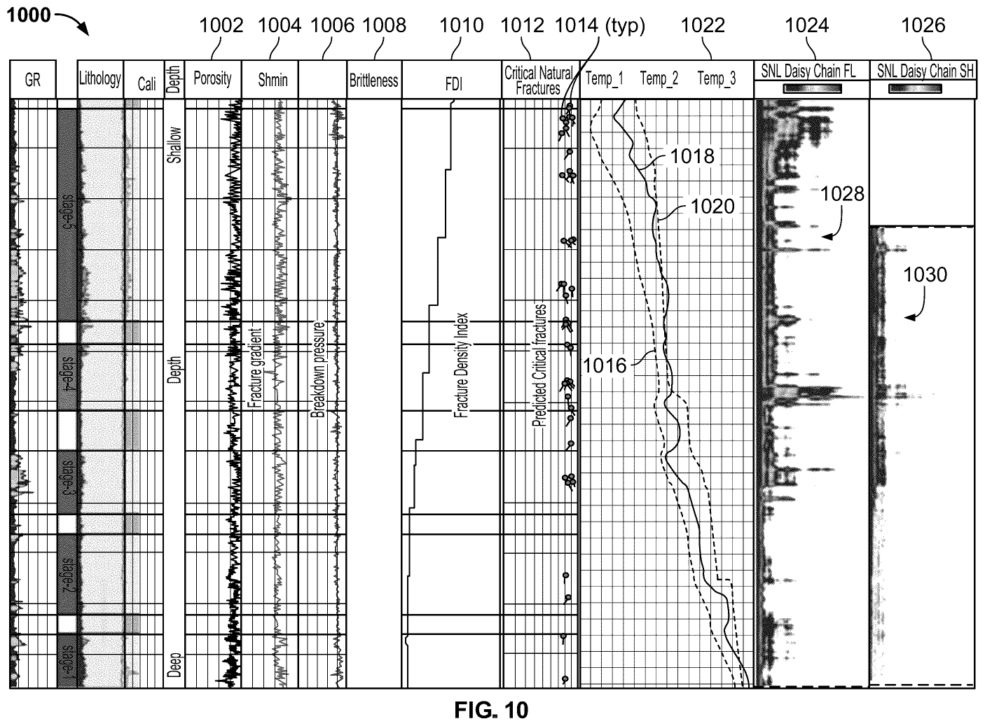

As part of the 3D natural fracture model, a rock brittleness index and fracture density index can be developed. For example, a rock brittleness property can be differentiated when subjected to stress; it breaks without significant plastic deformation. Brittle materials absorb relatively little energy prior to fracture, even those of high strength. In a complex heterogeneous fracture rock mass, the brittleness property can be modeled using neural network classification taking as inputs the elastic properties and stress regime producing mechanical facies. Those mechanical facies can have some proportional relation with the distribution of natural fractures. An example output from the integrated fracture model is discussed with reference to FIG. 10.

In some implementations, a completion design for the well can be selected based on the dynamic test and the one or more diagnostic well logs (step 210). The completion design can be installed in the well prior to targeted stimulation of the subsurface formation.

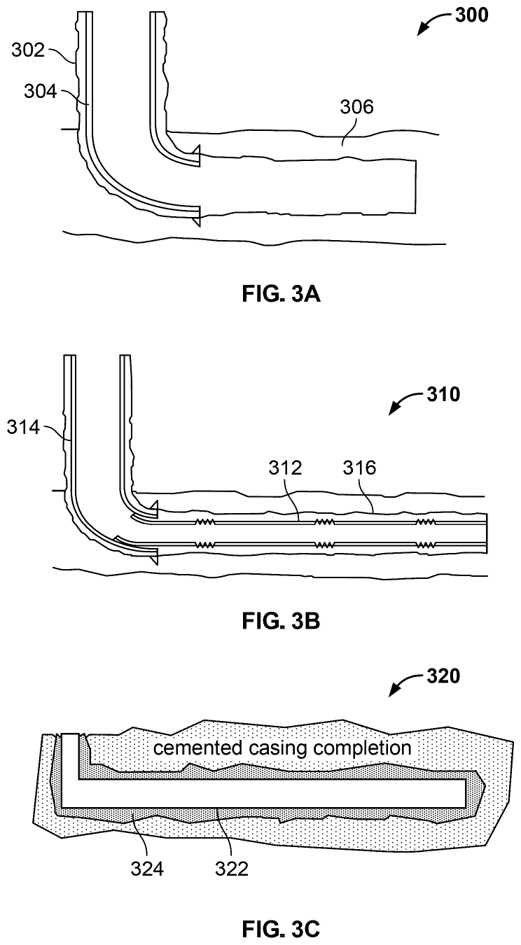

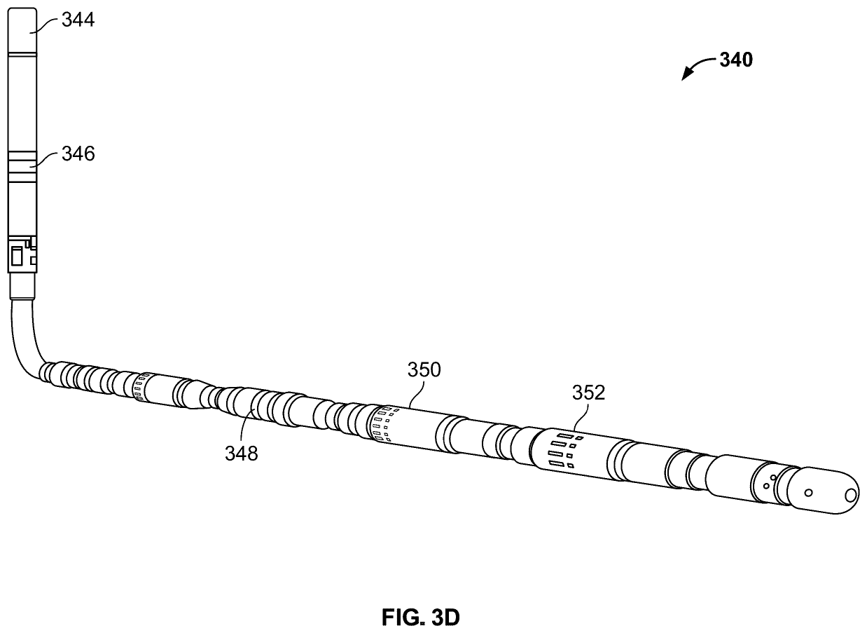

FIGS. 3A-3D show example completions that can be run in the well. FIG. 3A is an example openhole, barefoot completion 300. In this example, the borehole 302 includes casing and/or tubing in the vertical portion 304 of the borehole 302, but not in the horizontal portion 306. In a competent formation with a high intensity of natural fractures the openhole, barefoot completions (e.g., completion 300) can be the preferred choice of completion to take advantage of the exposed natural fractures.

FIG. 3B shows an example openhole completion 310 with a pre-perforated (e.g., slotted) liner 312. The vertical portion 314 of the borehole includes casing and/or tubing, and the horizontal portion 316 includes the pre-perforated liner 312. In a not-so-competent, weak formation that has natural fractures some sort of wellbore support is needed to avoid the formation from collapsing during production. In such a situation a slotted liner completion (e.g., completion 310) is run in the openhole to support the wellbore.

Openhole completions 300, 310 do not have zonal compartmentalization. In such types of completions, it is feasible to run a pre-stimulation diagnostic test before or after the completion is run.

FIG. 3C shows a cemented liner completion 320. The liner 322 is cemented in the borehole 324. The cemented liner completion allows particular intervals behind the liner to be selectively perforated yielding control of the production and injection of fluids in the perforated intervals.

FIG. 3D is an example of a completion 340 with openhole packers and multi-stage frac sleeves. Latch seal assembly 344 and liner hanger packer 346 are sealing devices that anchor fracturing and production strings to intermediate casing. Short open hole mechanical packer 348 is hydraulically set and provides isolation between target fracturing stages in the open hole of the wellbore. Other types of openhole packers such as swell packers, metal expandable packers, inflatable packers, or other materials (other than cement) that can form an annular seal can also be used in place of the mechanical packer 348. Ball actuated fracturing valve 350 is opened for fracturing operations by dropping specifically sized balls from the surface that land on designated seats within the valve. Pressure actuated valve 352 initiates circulation in the toe stage to facilitate ball drop operations to fracture upper stages.

Both completions 320, 340 provide reservoir compartmentalization and zonal isolation between the zones. Once run these completions make it difficult to run diagnostic treatments. In such cases, the diagnostic logging can be performed prior to running the completion.

Turning back to FIG. 2, targeted stimulation of the subsurface formation is performed at the identified zones in the well (step 212). The stimulation techniques for targeted stimulation can be tailored for each completion type in the well. For example, openhole completions (e.g., completions 310, 320) cannot be selectively stimulated using conventional bull-heading fracturing treatments because there is no zonal compartmentalization. For these types of completions, hydrajet-assisted hydraulic fracturing (HJHF) can be an effective tool in creating perforations where desired. The focused energy HJHF provides can stimulate zones of interest without using bridge plugs or packers. Another example of a targeted stimulation technique is cutting circular notches in the well bore. These circular notches become the initiation points for fracture generation and propagation.

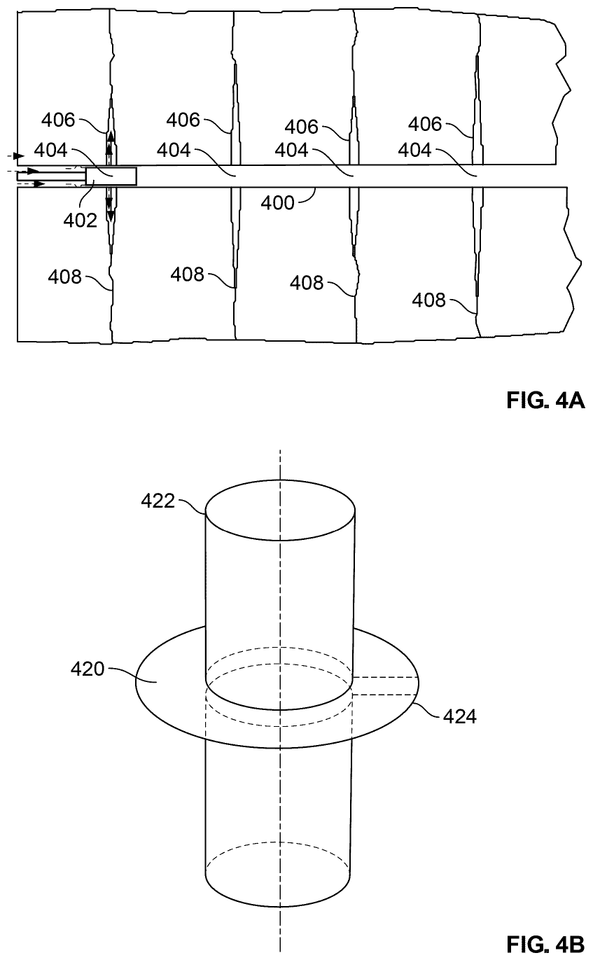

FIG. 4A shows a schematic illustration of HJHF targeted stimulation. A hydrajet 402 is run in the wellbore 400. At selected locations 404, the hydrajet 402 cuts notches 406 into the formation. Fractures 408 develop at the end of the notches 406.

FIG. 4B is a schematic illustration of a circular notch 420 cut in a vertical wellbore 422. Fractures develop at the end 424 of the circular notch 420.

In completions using openhole packers with multi-stage fracturing sleeves and cemented liners (e.g., completions 320, 340) the selective stimulation options are well established in the industry (e.g., Perf & Plug, Packer & Sleeve). The zones to be stimulated are identified based on the diagnostic logs and dynamic well tests (e.g., injection tests and production tests).

Following targeted stimulation, hydrocarbons can be produced from the well. In some implementations, a data processing system (e.g., a computer or control system) generates commands to cause control of hydrocarbon production equipment to produce hydrocarbons from the subsurface reservoir.

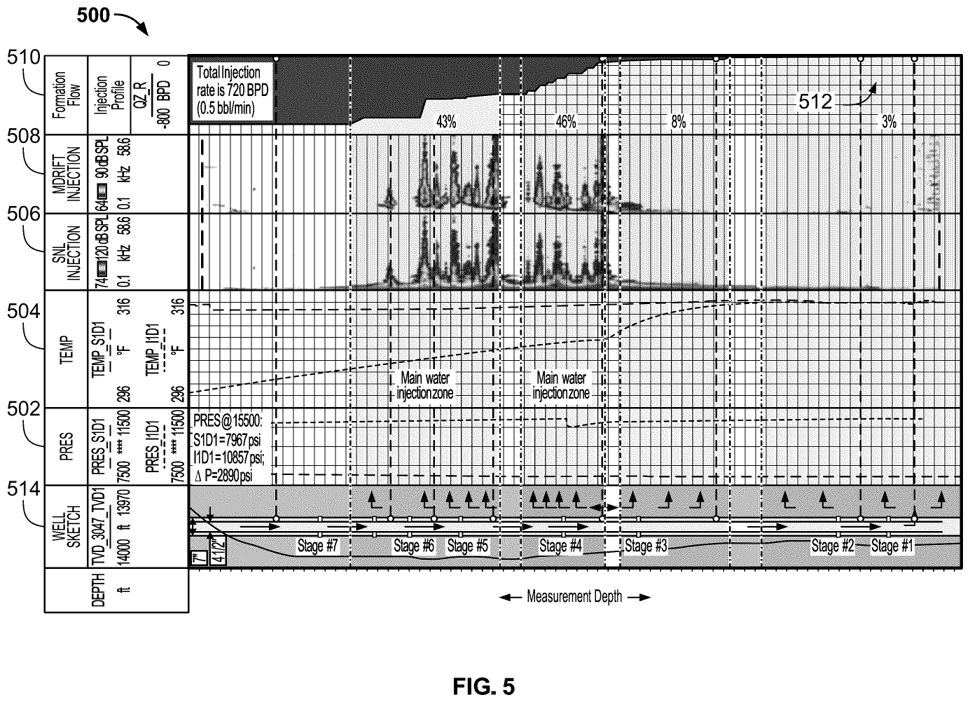

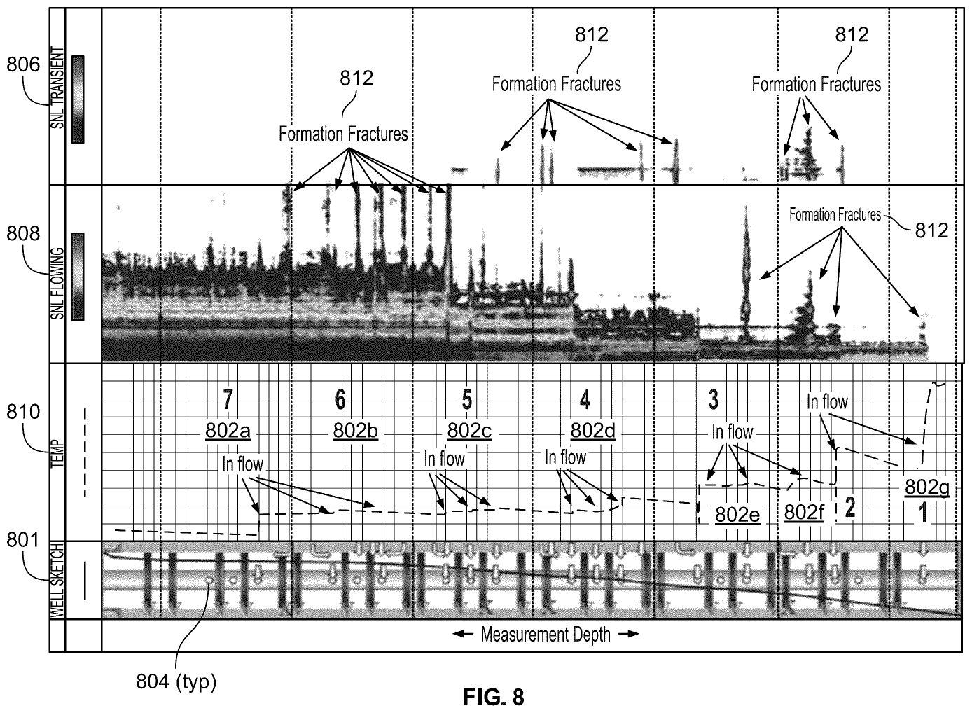

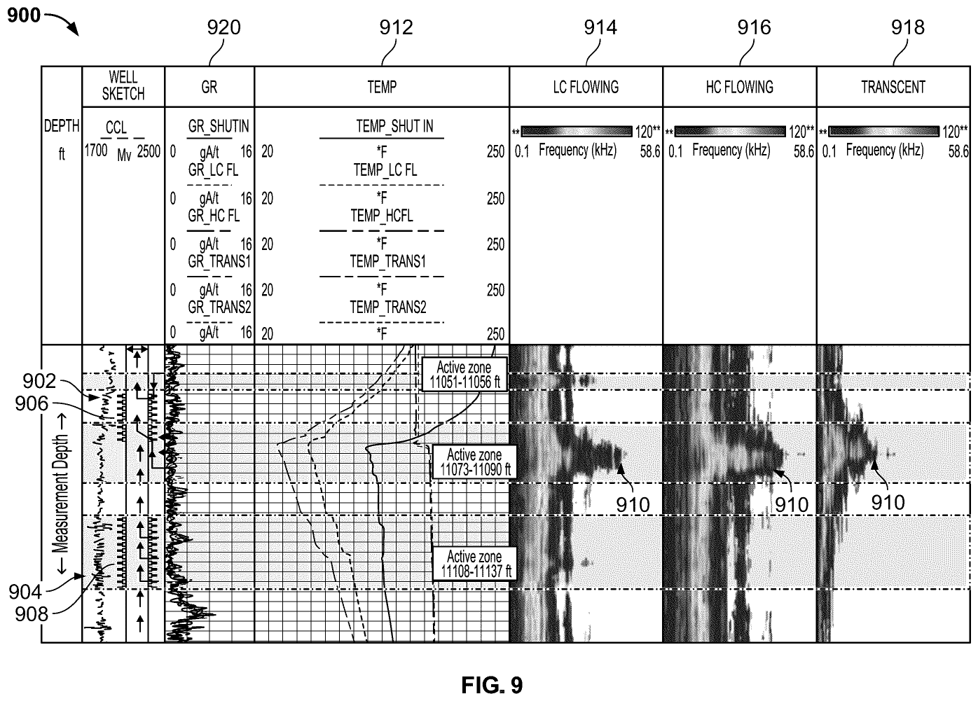

FIGS. 5-9 show examples of fluid distribution profiles in openhole and cased hole completions. Fluid distribution in a long lateral can be highly dependent on the heterogeneity of the reservoir where natural fractures and high permeability streaks can dominate most of the fluid intake at certain injection rates. By changing the injection rates a varied fluid distribution profile can be generated. In a production mode, a different fluid distribution profile can be revealed from the same wellbore where prolific zones at deeper depths produce without the deeper zones' contributions being masked by shallower prolific zones. Two of the examples (FIGS. 5-7) are performed prior to hydraulic fracturing of the well and two of the examples (FIGS. 8-9) are preformed after hydraulic fracturing. These examples show how to identify the best producing zones in different completions and the option for choosing the most effective stimulation designs.

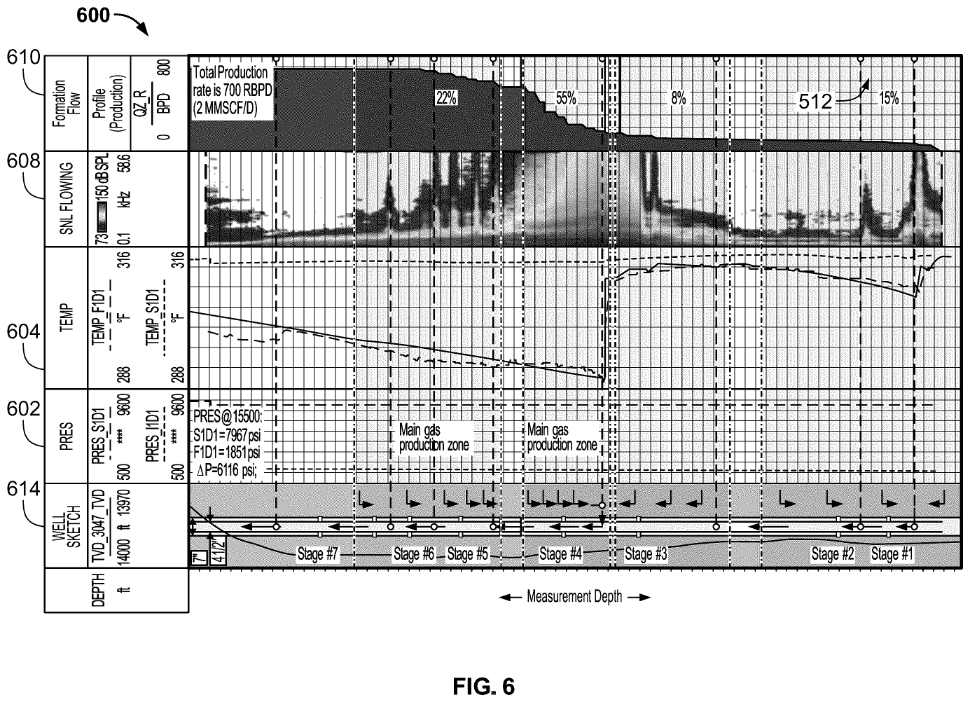

FIGS. 5-6 show example fluid distribution profiles for a horizontal gas well completed with openhole packers and multi-stage frac sleeves. The openhole packers however were not properly set and interzonal communication was observed through most of the wellbore.

FIG. 5 shows an example flow distribution profile 500 from an injection test using water. The flow distribution profile 500 includes pressure 502, temperature 504, SNL injection 506, median drift injection 508, and formation flow rate 510. The median drift injection 508 shows post-processing results of the raw SNL data. The raw SNL data has been filtered to remove background noise from the wellbore. The toe end zone 512 received a small portion (<3%) of the injection fluid during the injection test. A well sketch 514 is also shown.

FIG. 6 shows an example flow distribution profile 600 from a production test flowing gas. The flow distribution profile 600 includes pressure 602, temperature 604, SNL flowing 608, and formation flow rate 610. The SNL flowing 608 log is an SNL log taken during the production test. A well sketch 614 is also shown. The injection test and production test established interzonal communication within the wellbore and generated different flow distribution profiles. The toe end zone 512 had 15% contribution in the production mode as compared with the less than 3% in the injection mode. This highlights the role of using different fluids for the tests at different rates and in different flow modes to properly identify the prolific zones for stimulation.

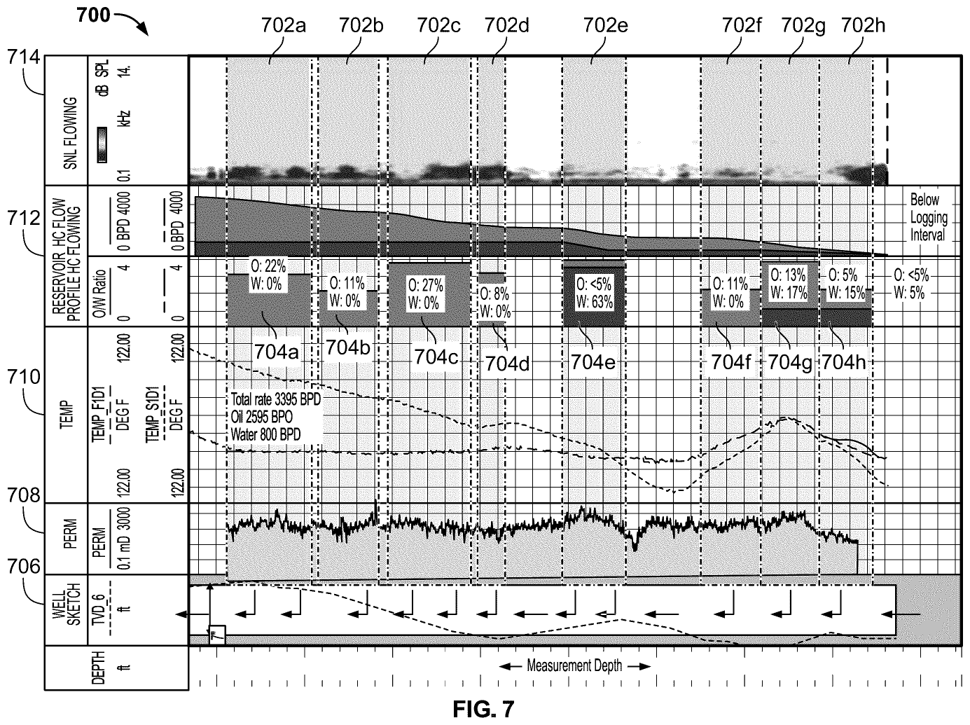

FIG. 7 is an example production profile 700 for an openhole, barefoot, horizontal oil well completion. The well is under production with no stimulation performed showing different zones 702a-h producing with different water-oil-ratios 704a-h. There are no indications of natural fractures from the noise log spectrum display or the production profile. The production profile 700 shows a well sketch 706, permeability 708, temperature 710, flow rate 712 and SNL 714.

FIG. 8 shows an example production profile 800 for an unconventional gas well completed with openhole packers and frac sleeves. Well sketch 801 shows the layout of the completion. This completion has 7 stages 802a-g with 19 ports 804 aiming to place 19 fractures. The interpretation of spectral noise logging 806, 808 and high precision temperature logs 810 after multi-stage fracturing identified the presence of 22 active fractures 812, 17 fractures were offset from flow ports 804, and 5 fractures aligned with the flow ports 804 with unique signatures. The fracture distribution varied between stages 802a-g with an average of 3 active fractures per stage with exception of stage 802a near the heel with only one induced active fracture, and stage 802b with almost 6 contributing active fractures. Note that production of stages 802a and 802d was from fractures created in unplanned spaces between the dual hydraulic packers separating neighboring stages 802b and 802c, respectively. Those fractures contributed to the mentioned stages production apparently through the bypassed packers. This example highlights the issue of some natural fractures being “trapped” in unplanned spaces between packers with no inlet into the production tubing to contribute to production. It also shows that a single port frac point can lead to the creation of multiple fractures in an openhole, multi-stage fracture (OH-MSF) completion.

FIG. 9 shows a composite plot 900 of top and middle zone contributions from a conventional vertical, cemented liner gas well after a two-stage fracturing operation. The two stages 902, 904 are shown having two sets of perforations 906, 908. The perforation sets 906, 908 do not directly correspond with the production zones (e.g., zone 910) seen in the HPT log 912 or SNL logs 914 (at low choke flow condition), 916 (at high choke flow condition), 918 (at shut-in condition which shows the transient behavior of the SNL effect). This discrepancy in production contributing layers can be due to various reasons such as the created hydraulic fracture extending into upper and/or lower zones beyond the perforated interval 906, but it mainly points out that the contributing layers may not always correspond with the petrophysical log analysis (e.g., gamma ray log 920) and a dynamic flow test can help identify these situations.

Using the HPT/SNL log combination to locate fracture inflows and quantify inflow profiles in hydraulically fractured wells can be complemented by a 3D fracture model used for validating the presence of natural fractures. The integrated fracture model can predict the presence of natural fractures before performing stimulation. Fracture Density Index models can be constructed before planning the well location, to ensure good productivity by targeting specific areas where good quality rock, in terms of natural fracture presences, is expected to be found. providing an independent source of verification for the dynamic tests of method 200. The integrated fracture model can help identify zones which could have been damaged or plugged during the drilling phase and do not contribute during the dynamic fluid tests.

FIG. 10 is an example composite log 1000 generated from an integrated fracture model. The composite log 1000 includes tracks (by depth) of porosity 1002, fracture gradient 1004, breakdown pressure 1006, brittleness 1008, fracture density index (FDI) 1010, and predicted natural fractures 1012 with the tadpoles 1014, a HPT log 1022, an SNL 1024 under flowing conditions, and an SNL 1026 under shut-in conditions. As shown, the HPT log 1022 track includes three different temperature curves 1016, 1018, and 1020. taken during HPT logging runs in the wellbore. Together, the HPT log 1022 and SNL 1024 can be used to identify the flow contributing zones (or the absence of contributing zones) behind the casing in the wellbore.

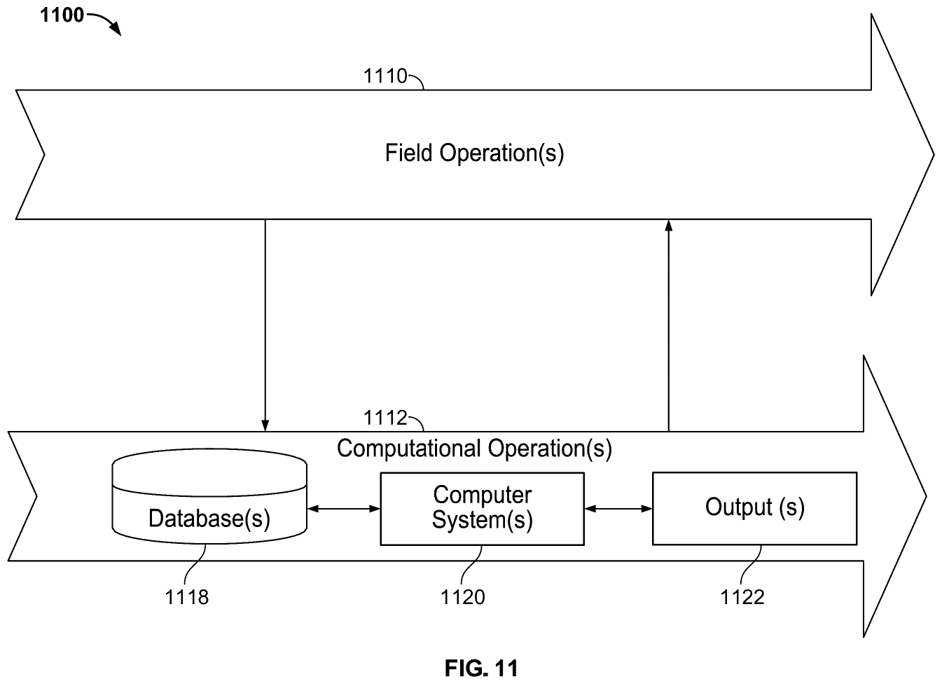

FIG. 11 illustrates hydrocarbon production operations 1100 that include both one or more field operations 1110 and one or more computational operations 1112, which exchange information and control exploration for the production of hydrocarbons. In some implementations, outputs of techniques of the present disclosure (e.g., the method 520) can be performed before, during, or in combination with the hydrocarbon production operations 1100, specifically, for example, either as field operations 1110 or computational operations 1112, or both.

Examples of field operations 1110 include forming/drilling a wellbore, hydraulic fracturing, producing through the wellbore, injecting fluids (such as water) through the wellbore, to name a few. In some implementations, methods of the present disclosure can trigger or control the field operations 1110. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1110 and responsively triggering the field operations 1110 including, for example, generating plans and signals that provide feedback to and control physical components of the field operations 1110. Alternatively, or in addition, the field operations 1110 can trigger the methods of the present disclosure. For example, implementing physical components (including, for example, hardware, such as sensors) deployed in the field operations 1110 can generate plans and signals that can be provided as input or feedback (or both) to the methods of the present disclosure.

Examples of computational operations 1112 include one or more computer systems 1120 that include one or more processors and computer-readable media (e.g., non-transitory computer-readable media) operatively coupled to the one or more processors to execute computer operations to perform the methods of the present disclosure. The computational operations 1112 can be implemented using one or more databases 1118, which store data received from the field operations 1110 and/or generated internally within the computational operations 1112 (e.g., by implementing the methods of the present disclosure) or both. For example, the one or more computer systems 1120 process inputs from the field operations 1110 to assess conditions in the physical world, the outputs of which are stored in the databases 1118. For example, seismic sensors of the field operations 1110 can be used to perform a seismic survey to map subsurface features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1112 where they are stored in the databases 1118 and analyzed by the one or more computer systems 1120.

In some implementations, one or more outputs 1122 generated by the one or more computer systems 1120 can be provided as feedback/input to the field operations 1110 (either as direct input or stored in the databases 1118). The field operations 1110 can use the feedback/input to control physical components used to perform the field operations 1110 in the real world.

For example, the computational operations 1112 can process the seismic data to generate three-dimensional (3D) maps of the subsurface formation. The computational operations 1112 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1112 to process new information about the formation and control the drilling to adjust to the observed conditions in real-time.

The one or more computer systems 1120 can update the 3D maps of the subsurface formation as information from one exploration well is received and the computational operations 1112 can adjust the location of the next exploration well based on the updated 3D maps. Similarly, the data received from production operations can be used by the computational operations 1112 to control components of the production operations. For example, production well and pipeline data can be analyzed to predict slugging in pipelines leading to a refinery and the computational operations 1112 can control machine operated valves upstream of the refinery to reduce the likelihood of plant disruptions that run the risk of taking the plant offline.

In some implementations of the computational operations 1112, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

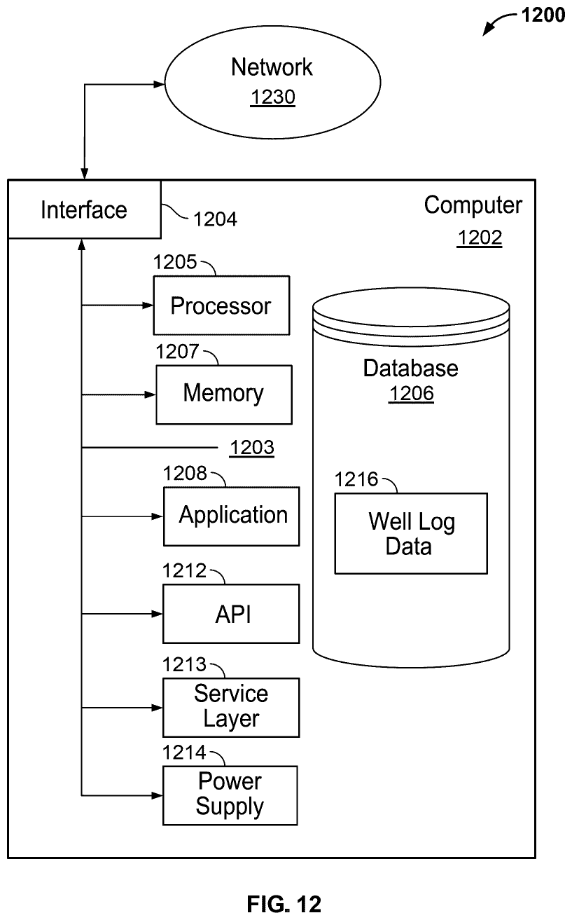

FIG. 12 is a block diagram of an example computer system 1200 used to provide computational functionalities associated with described algorithms, methods, functions, processes, flows, and procedures described in the present disclosure, according to some implementations of the present disclosure. The illustrated computer 1202 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1202 can include input devices such as keypads, keyboards, and touch screens that can accept user information. Also, the computer 1202 can include output devices that can convey information associated with the operation of the computer 1202. The information can include digital data, visual data, audio information, or a combination of information. The information can be presented in a graphical user interface (UI) (or GUI).

The computer 1202 can serve in a role as a client, a network component, a server, a database, a persistency, or components of a computer system for performing the subject matter described in the present disclosure. The illustrated computer 1202 is communicably coupled with a network 1230. In some implementations, one or more components of the computer 1202 can be configured to operate within different environments, including cloud-computing-based environments, local environments, global environments, and combinations of environments.

At a high level, the computer 1202 is an electronic computing device operable to receive, transmit, process, store, and manage data and information associated with the described subject matter. According to some implementations, the computer 1202 can also include, or be communicably coupled with, an application server, an email server, a web server, a caching server, a streaming data server, or a combination of servers.

The computer 1202 can receive requests over network 1230 from a client application (for example, executing on another computer 1202). The computer 1202 can respond to the received requests by processing the received requests using software applications. Requests can also be sent to the computer 1202 from internal users (for example, from a command console), external (or third) parties, automated applications, entities, individuals, systems, and computers.

Each of the components of the computer 1202 can communicate using a system bus 1203. In some implementations, any or all of the components of the computer 1202, including hardware or software components, can interface with each other or the interface 1204 (or a combination of both), over the system bus 1203. Interfaces can use an application programming interface (API) 1212, a service layer 1213, or a combination of the API 1212 and service layer 1213. The API 1212 can include specifications for routines, data structures, and object classes. The API 1212 can be either computer-language independent or dependent. The API 1212 can refer to a complete interface, a single function, or a set of APIs.

The service layer 1213 can provide software services to the computer 1202 and other components (whether illustrated or not) that are communicably coupled to the computer 1202. The functionality of the computer 1202 can be accessible for all service consumers using this service layer. Software services, such as those provided by the service layer 1213, can provide reusable, defined functionalities through a defined interface. For example, the interface can be software written in JAVA, C++, or a language providing data in extensible markup language (XML) format. While illustrated as an integrated component of the computer 1202, in alternative implementations, the API 1212 or the service layer 1213 can be stand-alone components in relation to other components of the computer 1202 and other components communicably coupled to the computer 1202. Moreover, any or all parts of the API 1212 or the service layer 1213 can be implemented as child or sub-modules of another software module, enterprise application, or hardware module without departing from the scope of the present disclosure.

The computer 1202 includes an interface 1204. Although illustrated as a single interface 1204 in FIG. 12, two or more interfaces 1204 can be used according to particular needs, desires, or particular implementations of the computer 1202 and the described functionality. The interface 1204 can be used by the computer 1202 for communicating with other systems that are connected to the network 1230 (whether illustrated or not) in a distributed environment. Generally, the interface 1204 can include, or be implemented using, logic encoded in software or hardware (or a combination of software and hardware) operable to communicate with the network 1230. More specifically, the interface 1204 can include software supporting one or more communication protocols associated with communications. As such, the network 1230 or the interface's hardware can be operable to communicate physical signals within and outside of the illustrated computer 1202.

The computer 1202 includes a processor 1205. Although illustrated as a single processor 1205 in FIG. 12, two or more processors 1205 can be used according to particular needs, desires, or particular implementations of the computer 1202 and the described functionality. Generally, the processor 1205 can execute instructions and can manipulate data to perform the operations of the computer 1202, including operations using algorithms, methods, functions, processes, flows, and procedures as described in the present disclosure.

The computer 1202 also includes a database 1206 that can hold data for the computer 1202 and other components connected to the network 1230 (whether illustrated or not). For example, database 1206 can be an in-memory, conventional, or a database storing data consistent with the present disclosure. In some implementations, database 1206 can be a combination of two or more different database types (for example, hybrid in-memory and conventional databases) according to particular needs, desires, or particular implementations of the computer 1202 and the described functionality. Although illustrated as a single database 1206 in FIG. 12, two or more databases (of the same, different, or combination of types) can be used according to particular needs, desires, or particular implementations of the computer 1202 and the described functionality. While database 1206 is illustrated as an internal component of the computer 1202, in alternative implementations, database 1206 can be external to the computer 1202.

The computer 1202 also includes a memory 1207 that can hold data for the computer 1202 or a combination of components connected to the network 1230 (whether illustrated or not). Memory 1207 can store any data consistent with the present disclosure. In some implementations, memory 1207 can be a combination of two or more different types of memory (for example, a combination of semiconductor and magnetic storage) according to particular needs, desires, or particular implementations of the computer 1202 and the described functionality. Although illustrated as a single memory 1207 in FIG. 12, two or more memories 1207 (of the same, different, or combination of types) can be used according to particular needs, desires, or particular implementations of the computer 1202 and the described functionality. While memory 1207 is illustrated as an internal component of the computer 1202, in alternative implementations, memory 1207 can be external to the computer 1202.

The application 1208 can be an algorithmic software engine providing functionality according to particular needs, desires, or particular implementations of the computer 1202 and the described functionality. For example, application 1208 can serve as one or more components, modules, or applications. Further, although illustrated as a single application 1208, the application 1208 can be implemented as multiple applications 1208 on the computer 1202. In addition, although illustrated as internal to the computer 1202, in alternative implementations, the application 1208 can be external to the computer 1202.

The computer 1202 can also include a power supply 1214. The power supply 1214 can include a rechargeable or non-rechargeable battery that can be configured to be either user- or non-user-replaceable. In some implementations, the power supply 1214 can include power-conversion and management circuits, including recharging, standby, and power management functionalities. In some implementations, the power-supply 1214 can include a power plug to allow the computer 1202 to be plugged into a wall socket or a power source to, for example, power the computer 1202 or recharge a rechargeable battery.

There can be any number of computers 1202 associated with, or external to, a computer system containing computer 1202, with each computer 1202 communicating over network 1230. Further, the terms “client,” “user,” and other appropriate terminology can be used interchangeably, as appropriate, without departing from the scope of the present disclosure. Moreover, the present disclosure contemplates that many users can use one computer 1202 and one user can use multiple computers 1202.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described. Nevertheless, it will be understood that various modifications may be made without departing from the spirit and scope of this disclosure. Accordingly, other embodiments are within the scope of the following claims.

### EXAMPLES

In an example implementation, a method for performing targeted stimulation of a well drilled in a subsurface formation includes performing a dynamic well test in the well; logging the well to generate one or more diagnostic well logs prior to stimulating the subsurface formation; identifying one or more zones in the well for targeted stimulation based on the injection test and the one or more diagnostic well logs; and performing the targeted stimulation at the identified one or more zones.

In an aspect combinable with the example implementation, logging the well to generate one or more diagnostic well logs includes performing at least one spectral noise logging run to generate at least one spectral noise log of the well; and performing at least one high-precision temperature logging run to generate at least one high-precision temperature log of the well.

Another aspect combinable with any of the previous aspects includes selecting a completion design for the well based on the injection test and the one or more diagnostic well logs; and installing the selected completion design in the well.

Another aspect combinable with any of the previous aspects includes validating the injection test and the one or more diagnostic well logs using an integrated fracture model of the subsurface formation.

In another aspect combinable with any of the previous aspects, the integrated fracture model includes a three-dimensional natural fractures model using a fracture density index; and a three-dimensional mechanical stratigraphy model using a brittleness index.

In another aspect combinable with any of the previous aspects, performing the targeted stimulation includes performing hydrajet-assisted hydraulic fracturing.

Another aspect combinable with any of the previous aspects includes controlling hydrocarbon production equipment to produce hydrocarbons from the well.

In another aspect combinable with any of the previous aspects, performing a dynamic test in the well includes performing at least one of a production test or an injection test on the well.

In another aspect combinable with any of the previous aspects, the production test uses a different fluid than the injection test.

In another example implementation, a system for performing targeted stimulation of a well drilled in a subsurface formation includes at least one processor; and a memory storing instructions that, when executed by the at least one processor, cause the at least one processor to perform operations including performing a dynamic well test in the well; generating one or more diagnostic well logs prior to stimulating the subsurface formation; identifying one or more zones in the well for targeted stimulation based on the injection test and the one or more diagnostic well logs; and performing the targeted stimulation at the identified one or more zones.

In an aspect combinable with the example implementation, generating one or more diagnostic well logs includes generating at least one spectral noise log of the well; and generating at least one high precision temperature log of the well.

Another aspect combinable with any of the previous aspects includes selecting a completion design for the well based on the dynamic test and the one or more diagnostic well logs.

Another aspect combinable with any of the previous aspects includes validating the dynamic test and the one or more diagnostic well logs using an integrated fracture model of the subsurface formation.

In another aspect combinable with any of the previous aspects, the integrated fracture model includes a three-dimensional natural fractures model using a fracture density index; and a three-dimensional mechanical stratigraphy model using a brittleness index.

In another aspect combinable with any of the previous aspects, performing the targeted stimulation includes performing hydrajet-assisted hydraulic fracturing.

Another aspect combinable with any of the previous aspects includes controlling hydrocarbon production equipment to produce hydrocarbons from the well.

In another aspect combinable with any of the previous aspects, performing a dynamic test in the well includes performing at least one of a production test or an injection teston the well.

In another aspect combinable with any of the previous aspects, the production test uses a different fluid than the injection test.

In another example implementation, one or more non-transitory machine-readable storage devices storing instructions for performing targeted stimulation of a well drilled in a subsurface formation, the instructions being executable by one or more processors, to cause performance of operations including performing a dynamic well test in the well; generating one or more diagnostic well logs prior to stimulating the subsurface formation; identifying one or more zones in the well for targeted stimulation based on the injection test and the one or more diagnostic well logs; and performing the targeted stimulation at the identified one or more zones.

In an aspect combinable with the example implementation, generating one or more diagnostic well logs includes generating at least one spectral noise log of the well; and generating at least one high precision temperature log of the well, and performing a dynamic test in the well includes performing at least one of a production test or an injection teston the well.

What is claimed is:

1. A method for performing targeted stimulation of a well drilled in a subsurface formation, the method comprising:
performing a dynamic well test in the well;
logging the well to generate one or more diagnostic well logs prior to stimulating the subsurface formation;
identifying one or more zones in the well for targeted stimulation based on the injection test and the one or more diagnostic well logs; and
performing the targeted stimulation at the identified one or more zones.

2. The method of claim 1, wherein logging the well to generate one or more diagnostic well logs comprises:
performing at least one spectral noise logging run to generate at least one spectral noise log of the well; and
performing at least one high-precision temperature logging run to generate at least one high-precision temperature log of the well.

3. The method of claim 1, further comprising: selecting a completion design for the well based on the injection test and the one or more diagnostic well logs; and
installing the selected completion design in the well.

4. The method of claim 1, further comprising: validating the injection test and the one or more diagnostic well logs using an integrated fracture model of the subsurface formation.

5. The method of claim 4, wherein the integrated fracture model comprises a three-dimensional natural fractures model using a fracture density index; and
a three-dimensional mechanical stratigraphy model using a brittleness index.

6. The method of claim 1, wherein performing the targeted stimulation comprises performing hydrajet-assisted hydraulic fracturing.

7. The method of claim 1, further comprising: controlling hydrocarbon production equipment to produce hydrocarbons from the well.

8. The method of claim 1, wherein performing a dynamic test in the well comprises performing at least one of a production test or an injection test on the well.

9. The method of claim 8, wherein the production test uses a different fluid than the injection test.

10. A system for performing targeted stimulation of a well drilled in a subsurface formation, the system comprising:
at least one processor; and
a memory storing instructions that, when executed by the at least one processor, cause the at least one processor to perform operations comprising:
performing a dynamic well test in the well;
generating one or more diagnostic well logs prior to stimulating the subsurface formation;
identifying one or more zones in the well for targeted stimulation based on the injection test and the one or more diagnostic well logs; and
performing the targeted stimulation at the identified one or more zones.

11. The system of claim 10, wherein generating one or more diagnostic well logs comprises:
generating at least one spectral noise log of the well; and
generating at least one high precision temperature log of the well.

12. The system of claim 10, further comprising: selecting a completion design for the well based on the dynamic test and the one or more diagnostic well logs.

13. The system of claim 10, further comprising: validating the dynamic test and the one or more diagnostic well logs using an integrated fracture model of the subsurface formation.

14. The system of claim 13, wherein the integrated fracture model comprises a three-dimensional natural fractures model using a fracture density index; and
a three-dimensional mechanical stratigraphy model using a brittleness index.

15. The system of claim 10, wherein performing the targeted stimulation comprises performing hydrajet-assisted hydraulic fracturing.

16. The system of claim 10, further comprising: controlling hydrocarbon production equipment to produce hydrocarbons from the well.

17. The system of claim 10, wherein performing a dynamic test in the well comprises performing at least one of a production test or an injection test on the well.

18. The system of claim 17, wherein the production test uses a different fluid than the injection test.

19. One or more non-transitory machine-readable storage devices storing instructions for performing targeted stimulation of a well drilled in a subsurface formation, the instructions being executable by one or more processors, to cause performance of operations comprising:
performing a dynamic well test in the well;
generating one or more diagnostic well logs prior to stimulating the subsurface formation;
identifying one or more zones in the well for targeted stimulation based on the injection test and the one or more diagnostic well logs; and
performing the targeted stimulation at the identified one or more zones.

20. The non-transitory, machine-readable storage devices of claim 19, wherein generating one or more diagnostic well logs comprises:
generating at least one spectral noise log of the well; and
generating at least one high precision temperature log of the well,
wherein performing a dynamic test in the well comprises performing at least one of a production test or an injection teston the well.
